(19) United States
(12) Patent Application Publication
(10) Pub. No.: US 2012/0221310 A1
(43) Pub. Date: Aug. 30, 2012

(54) SYSTEM FOR ANALYZING PHYSIOLOGICAL SIGNALS TO PREDICT MEDICAL CONDITIONS

(75) Inventors: Majid Sarrafzadeh, Anaheim Hills, CA (US); Jamie Macbeth, Somerville, MA (US)

(73) Assignee: THE REGENTS OF THE UNIVERSITY OF CALIFORNIA, Oakland, CA (US)

(21) Appl. No.: 13/407,683

(22) Filed: Feb. 28, 2012

Related U.S. Application Data
(60) Provisional application No. 61/447,639, filed on Feb. 28, 2011.

(51) Int. Cl. G06G 7/60

(52) U.S. Cl. 703/11

(57) ABSTRACT

A signal representing a physiological state of a patient is sampled to obtain a time lagged dataset that represents a segment of the signal. A spectral analysis of the dataset is conducted to obtain a corresponding frequency domain dataset, followed by a multiple regression analysis using the frequency domain set as one variable and a signal representative of a medical event as the other variable. The result of the multiple regression analysis is used to create a model for predicting the medical event.

### CROSS-REFERENCE TO RELATED APPLICATION

This application claims the benefit of U.S. Provisional Application No. 61/447639, filed Feb. 28, 2011, which is hereby expressly incorporated by reference herein.

### BACKGROUND

The present invention relates to patient monitoring, and particularly to examination of datasets of one or more physiological signals of a patient to establish correlation of the data with a medical event, development of a model that can be used to predict the medical event, and use of the model for predicting the medical event.

In general, medical embedded systems are capable of recording vast datasets for physiological and medical research. The physiological conditions represented and the signals themselves are almost limitless. Data to be collected may be single or multi-channeled, and different datasets may have different sampling rates, signal-to-noise ratios, various signal characteristics, and so on. Furthermore, data is collected using a variety of diagnostic devices and health sensors in different environments.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a system for determining a relationship between one medical signal or parameter and one or more others. These physiological quantities are modeled as variables in a linear model. Regression is used to discover correlations between the quantities. The system performs efficient linear model regressions for correlation studies and for prediction to aid in clinical research and health care environments. For signal data that may represent the onset or degree of the medical condition or phenomenon in question, the system performs pattern matching and learns signal patterns.

In one aspect of the invention, a spectral analysis of time-lagged periodic samples of a continuous physiological signal is performed to determine waveform frequency components. Multiple regression is performed on: (1) the frequency components of the samples of the physiological signal; and (2) a signal representative of a medical condition, such as a harmful medical condition. A model is developed by means of which the physiological signal can be used to predict the condition or a signal representative of the condition.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of a representative architecture for a system in accordance with the present invention; and

FIG. 2 is a diagram representing a method of developing a predictive model in accordance with the present invention.

### DETAILED DESCRIPTION

The present invention is concerned with measurements of physiological variables through data collected on a subject/patient in medical monitoring studies or applications. The invention can be used to determine whether or not the variables go together or covary. In general terms, one aspect of the invention is to determine the relationship between an independent variable and one or more dependent variables, the purpose being to assess the effects of variations in the independent variable on the dependent variable as a response measure. Studies of this kind are correlational in that they attempt to determine whether or not two variables influence each other. Regression measures and estimates the strength and direction of these relationships.

In typical physiological studies, signals of interest may be sampled at a far higher rate than the rate in which they influence each other, and they may be sampled at different rates than each other. Additionally, the time scales under which signals influence each other may not be known, and the functional form under which the relationship is modeled is important to the success of regression techniques. The present invention proposes efficient algorithms for time lag regression over model selection for use in physiological studies, because relationships between measurements of physiological quantities tend to be dynamic in the sense that variations in an independent variable may take time to impact a dependent variable, and the impact may be long-lived.

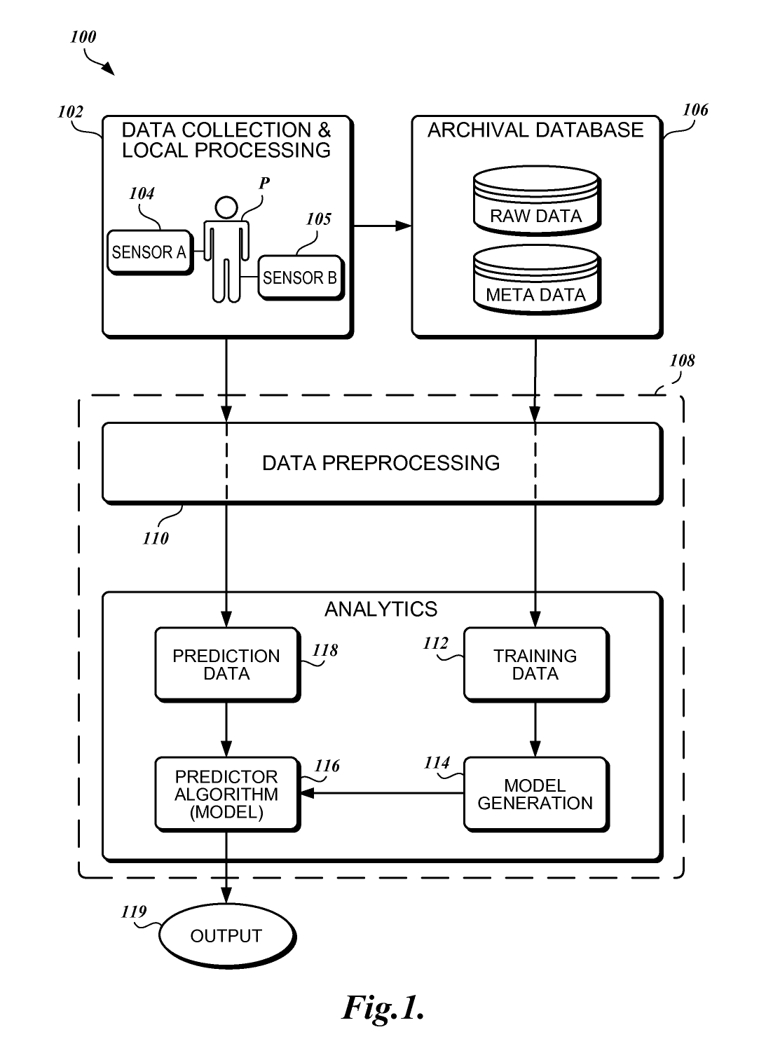

With reference to FIG. 1, one generalized architecture for the present invention is a system 100 for analyzing physiological signals for medical diagnosis. Starting at box 102, one or more sensor devices 104, 105 are configured to detect physiological conditions in a patient P. Exemplary sensor devices include, but are not limited to, a respiratory inductance plethysmograph, a pulse oximeter, an electrocardiograph device, an electroencephalograph device, a catheter configured to measure blood pressure, and so on. Each of the sensor devices 104, 105 generates a signal based on a physical measurement of a physiological state associated with the patient, the signal comprising a time series of values.

Following the branch to the right of box 102, the output signals of sensor devices 104, 105 can be sent to and stored in a memory component to create an archival database 106. Database 106 can decode and store a segment of the raw data representing the signal from one or more sensors 104, 105 and meta data which can include the patient's demographic such as name, gender, ethnicity, date of birth, and so on, as well as any information regarding the data collection system such as type, manufacturer, model, sensor ID, sampling frequency, and the like. At a desired later time, one or more data segments of interest are communicated to a signal processing device represented at 108. The signal processing device 108 is a computing device configured to obtain data generated by the sensor devices 104, 105 and to perform calculations based on the obtained data. In one embodiment, the computing device may include at least one processor, an interface for coupling the computing device to the database 106, and a nontransitory computer-readable medium. The computer-readable medium has computer-executable instructions stored thereon that, in response to execution by the processor, cause the signal processing device 108 to perform the described calculations on the obtained data. One example of a suitable computing device is a personal computer specifically programmed to perform the actions described herein. This example should not be taken as limiting, as any suitable computing device, such as a laptop computer, a smartphone, a tablet computer, a cloud computing platform, an embedded device, and the like, may be used in various embodiments of the present disclosure.

As described in more detail below, the time segment of archived data is preprocessed (box 110) to a form for further analyzing in accordance with the invention. The result is an altered dataset which can be referred to as “training data” (box 112). The training data is used to create a model that indicates the correlation between the preprocessed sensor data from the archive and a medical event of interest. In FIG. 1, model generation is represented at 114 and the resulting model stored in the computing device is represented at 116.

Returning to box 102, once the model 116 has been generated, the sensor devices 104, 105 can be coupled to the signal processing device 108 by a real-time connection, such as by a serial cable, a USB cable, a local network connection, such as a Bluetooth connection, a wired local-area network connection, a WIFI connection, an infrared connection, and the like. In another embodiment, the sensor devices 104, 105 may be coupled to the signal processing device 108 by a wide area network, such as the Internet, a WiMAX network, a 3G network, a GSM network, and the like. The sensor devices 104, 105 may each include network interface components that couple each sensor device 104, 105 to the signal processing device 108. Alternatively, the sensor devices 104, 105 may each be coupled to a shared networking device via a direct physical connection or a local network connection, which in turn establishes a connection to the signal processing device 108 over a wide area network.

The direct physical connection embodiments and the local area network connection embodiments may be useful in a scenario when the sensor devices 104, 105 are located in close proximity to the signal processing device 108, such as within the same examination room in a clinic. The wide area network embodiments may be useful in a larger telehealth or automated diagnosis application.

In this branch (the real time branch) the signals from the sensor devices are. preprocessed (box 110) to the same format as the archived data during model generation, resulting in “prediction data” represented at 118. Ultimately the signal processing device 108 uses the model 116 to examine the prediction data and provide an output (represented at 119) of a prediction of a medical event that was found to be correlated to the input from the sensor(s) based on the training data. The types of medical event with which the present invention is concerned are those for which the correlation with the physiological data is established and modeled as described herein. Depending on the event and the established relationship, the output may be binary (yes/no) or have more than two digital quantities to indicate a predictive probability or a degree of presence or severity. The output can be on a display or by means of a signal, for example.

In the present invention, the correlation of the physiological data with the occurrence of the medical event is established by a multiple regression analysis. For the analysis, let Y represent a dependent or criterion variable indicative of the medical event of interest, and let X₁, X₂, X₃, . . . , Xₙ represent independent or predictor variables (i.e., the data derived from the sensor or sensors) of Y. An observation of Y coupled with observations of the independent variables Xᵢ is a case or a run of an experiment. Typically observations of values for any given variable will form a continuous, totally-ordered set. In cases where a variable is categorical or probabilistic (such as a 0 or 1 representing presence or absence or a medical condition) a logistic function is used to represent the regression model.

In experimental runs, score values of these variables are observed from a population. It is assumed that any dataset used is a sample from a population as larger group. Multiple regression methods will attempt to derive or calculate a constant β₀ and a set of weights, β₁, β₂, β₃, . . . , βₙ for the predictor variables. In the equation

Ŷ=β₀+β₁X₁+β₂X₂+β₃X₃+ . . . +βₙXₙ+ε,

Ŷ is then used to predict the observations of Y given the observations of the Xi. The βi are called correlation coefficients, and ε is the uncorrelated error or disturbance. Regression fits the values from a set of observations to the model by estimating the correlation coefficients. Typically the coefficients are chosen so that Ŷ predicts Y with a minimum sum of squared errors for the sample. The model can be written as a summation

$$\hat{Y} = {β}_{0} + {\sum }_{i = 1}^{n} {β}_{i} {X}_{i} + ε .$$

Regression is used to predict time series values of the dependent variable Y based on time series data of the independent variable X. Ideally, time series data for X will be sampled at regular intervals and will be represented by the Xᵢ. Time series data for the dependent variable Y need not be sampled regularly. Observations of Yᵢ and Xᵢ will be made over a time period 0<t<T. Causality is assumed, and if Yₜ exists, Xₜ, Xₜ₋₁, 4ₜ₋₂, Xₜ₋₃, . . . X₀ can be used in a multiple regression to predict it.

The Xᵢ predictor variables of Y used in the model represent observations made periodically during a continuous time period beginning at some time before Y was observed and ending at the time of observation of Y. In accordance with the present invention, the model is a distributed lag model, and is useful when changes in the independent variable X have an effect on the value of Y over many samples of Y. Because two variables are involved, this is called a bivariate distributed lag model. Typically, if X and Y are observed at identical periods at the same frequency, T bivariate observations will be made of Yₜ and Xₜ. The set of predictor variables for Yₜ is restricted to n values of the time series in X represented by Xₜ₋₁, Xₜ₋₂, Xₜ₋₃, . . . Xₜ₋ₙ. The model can be succinctly written

$${\hat{Y}}_{t} = {β}_{0} + {\sum }_{i = 1}^{n} {β}_{i} {X}_{t - i} + ε .$$

As distributed time-lagged regression is performed over signals, where the time scales of the alleged correlations between the two waveforms may be much longer than their sampling frequencies, it is desirable to manage the number of predictors. For example, in the present invention, the predictor data needs to cover the time-lag region in which the suspected correlation is in place. The present invention uses spectral characteristics of the predictor signal in the regression, which the inventors have found to be particularly useful for physiological signals that have periodic characteristics. More specifically, rather than simply perform multiple regression with time-lagged predictors, multiple regression is used with coefficients from a Fourier transform of the predictor signal as predictors. In a preferred embodiment, a fast Fourier transform (FFT) of a segment of the predictor signal residing in a time lagged window is used to predict the exogenous signal.

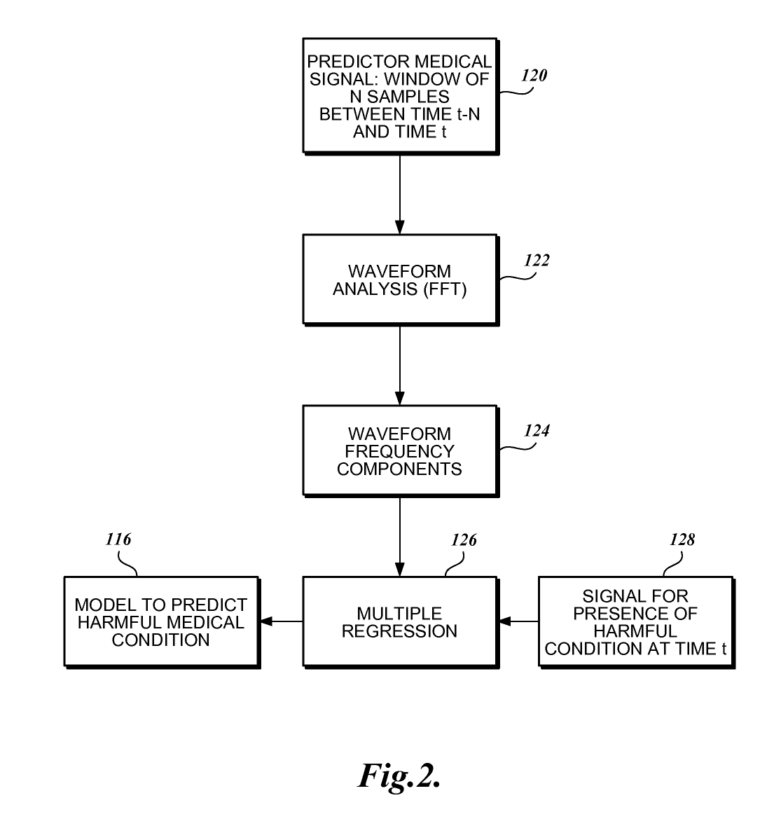

The basic steps in the creation of the model are represented in FIG. 2. The predictor medical signal is sampled to obtain N samples between time t−N and time t. (box 120). A spectral analysis (122; FFT in a preferred embodiment) is used to obtain the waveform frequency components (124) which are used in the multiple regression analysis (126). Another variable for the multiple regression analysis is a signal of the medical event of interest at time t (128). This can be a binary signal of a harmful medical condition indicating that the condition was present or absent, for example. The various observations are used in the multiple regression to set the values of the various coefficients of the predictors in the linear function. In the present invention, the predictor values are the spectral components of the predictor signal. The result is the model (116) that will reside in the signal processing device (108 in FIG. 1). The signal processing device derives the time lagged, spectrum analyzed predictor data signal from a sensor device and uses the processed signal and the model to provide the output that indicates the prediction of the medical event.

As distributed time-lagged regression is performed on the signals, the time scales of the alleged correlations between the two waveforms may be much longer than their sampling frequencies, and it may be desirable to manage the number of predictors. The predictors need to cover the time-lag region in which the suspected correlation is in place.

It has been observed that the use of spectral information (e.g., FFT) requires the use of many predictors in the model for the bandwidths of signals in use. However, multiple regression often benefits when less predictors can be used. The goal of reducing the independent variable set may be achieved when representative predictors are used, and when predictors can be placed in groups with similar characteristics.

The placement of predictors into similar groups in the present invention can be achieved by the use of a clustering algorithm. Clustering algorithms group sets of observations, usually according to a parameter k representing the desired number of clusters to be found by the algorithm. Hierarchical clustering algorithms solve the clustering problem for all values of k using bottom up and top down methods.

One suitable hierarchical clustering algorithm for use in the present invention is called AGNES (see L. Kaufman and P. J. Rousseeuw. Finding Groups in Data, An Introduction to Cluster Analysis, Hoboken, N.J., Wiley-Interscience, 2005, which is hereby expressly incorporated by reference herein) to cluster the spectral predictors based on three criteria obtained from a multiple regression performed on the FFT coefficients. As measures of similarity used in clustering, these criteria are the FFT index, the regression coefficient estimates themselves, and the regression coefficient t values.

The AGNES algorithm constructs a hierarchy of clusterings. At first, each observation is a small cluster by itself. Clusters are merged until only one large cluster remains containing all of the observations. At each stage the two nearest clusters are combined to form one larger cluster. The AGNES algorithm also yields the agglomerative coefficient (a value between 0 and 1) which measures the amount of clustering structure found.

Tests were conducted to evaluate a model developing system in accordance with the present invention using regression predictor clustering on data from the PhysioNet project (www.physionet.org). PhysioNet provides free access to large databases of physiological signal datasets via the web. Open-source software and libraries are also provided for mining and analysis. The associated PhysioBank database is an archive of physiological signals provided freely to the telehealth research community, and its many multi-parameter datasets are useful to for correlation and regression studies. It contains cardiopulmonary and neurological data and even gait databases from both healthy subjects and subjects under treatment, and many datasets include professional annotations.

The tests used a dataset from the MIT-BIH Polysomnographic Database (see Y. Ichimaru and G. Moody, “Development of the polysomnographic database on cd-rom,” Psychiatry and Clinical Neurosciences, 53, 1999, 175-177, hereby expressly incorporated by reference herein). The subjects were monitored for evaluation of chronic obstructive sleep apnea syndrome at Boston's Beth Israel Hospital Sleep Laboratory. Subjects were also monitored to test the effects of a standard therapeutic intervention to prevent or substantially reduce airway obstruction called constant positive airway pressure (CPAP). The database consists of four-, six-, and seven-channel polysomnographic recordings, and contains over 80 hours' worth of data.

The recording that was chosen, SLP59, includes an ECG signal, an invasive blood pressure signal (measured using a catheter in the radial artery), an EEG signal, and two respiration signals—one signal from a nasal thermistor and the second being a respiratory effort signal derived by inductance plethysmography. The dataset also includes a cardiac stroke volume signal and an earlobe oximeter signal. All signals are sampled at a rate of 250 Hz. The dataset also contains annotation files. The ECG signal has beat-by-beat annotations, and the EEG and respiration signals are annotated with respect to sleep stages and apnea.

In the tests the abdominal plethysmography respiration signal was used as the independent variable, and the oxygen saturation signal as the dependent variable. More specifically, at the occurrence of a sleep apnea event, airflow through respiration is reduced, and there is a corresponding decline that can be observed in the oxygen saturation level. Oxygenation later increases when the sleep apnea event subsides. The object of the tests was to determine the reliability of a system in accordance with the present invention in finding a relationship between the abdominal plethysmography respiration signal and the oxygen saturation signal.

Reliability was determined by an analysis of variance, R², a scale-free measure representing the percentage of the variance in the data that is explained by the model, as a measure of the accuracy of the regression. In the equation

$${R}^{2} = \frac{E [ {( \hat{Y} - E [ Y ] )}^{2} ]}{E [ {( Y - E [ Y ] )}^{2} ]} .$$

the numerator is the “model” sum of squared differences between the value of Y predicted by the model and the value of Y actually seen in each observation. The denominator is the “total” sum of squared differences between observations of Y and the mean of Y. This is a biased estimator of the true value of R² in the population, but it is assumed that there are enough observations to overcome this bias. The greater the value of R², the better the fit of the model.

3600 samples of the dataset were used to construct a time series to be fit to a bivariate distributed lag linear model. The data was downsampled to a rate of 1 Hz in order to provide for longer lags. The use of a finite distributed lag model requires the selection of a lag cutoff point beyond which there are no lagged variables. For simplicity, in this case, a lag cutoff of 30 samples was used, or, given the downsampling, 30 seconds.

The R software environment for statistical computing (R Development Core Team, R: A Language and Environment for Statistical Computing, R Foundation for Statistical Computing, Vienna, Austria, 2008, hereby expressly incorporated by reference herein) was used to perform the multiple regression without a spectral analysis of the signal. The intercept estimate had 95% confidence with a t value of 177.01. About half of the time-lagged variables have t values at the 95% confidence level, with the t value curve peaking at a time lag of 9 seconds. However, this model achieves an R² value of 0.016, indicating that very little of the variability in the dependent variable was captured in the model. Consequently, there was only moderate success using time-lagged multiple regression to predict blood oxygenation using the respiratory effort signal. Nevertheless, the plethysmographic waveform has a very periodic character as the patient inspires and expires air. Rather than simply perform multiple regression with time-lagged predictors, in accordance with the present invention multiple regression was proposed with coefficients from a Fourier transform of the predictor signal as predictors. In this study, a fast Fourier transform of a segment of the predictor signal residing in a time lagged window was used to predict the exogenous signal.

For the spectral regression algorithm, in total 90000 samples (360 seconds) of the dataset were used to construct a time series. Here the data was downsampled by a factor of 25 to a rate of 10 Hz. For each sample of the oximetry signal, a fast Fourier transform is performed on the segment of the predictor signal residing within a time-lagged window of 8000 samples (32 seconds). The first sample of the time-lagged window occurs at the same point in time as the dependent signal, and the last sample of the time-lagged window occurs at a point 8000 samples earlier.

Downsampling by a factor of 25× was performed. For accurate downsampling, rather than choose a single representative sample, the 10 samples for each signal were averaged. Smoothed samples were buffered and the fftw package (M. Frigo and S. G. Johnson, “The design and implementation of FFTW3,” Proceedings of the IEEE, 93(2), 2005, 216-231, hereby expressly incorporated by reference herein) was used to perform FFTs. Under the assumption that little phase information would be useful in the prediction, the moduli of the of the FFT coefficients were utilized as predictors.

The FFT coefficients which are used as predictors in the regression are to be distinguished from the regression coefficients β which appear in front of the FFT coefficient values in the model. The multiple regression used only FFT coefficients indexed 0-159, representing the frequency band from 0 to 5 Hz. It was observed that some of the lower-frequency FFT coefficients tend to have greater t values and thus greater validity. The regression resulted in a residual standard error of 0.7556 on 3118 degrees of freedom and a multiple R² of 0.90 indicating that 90% of the variability in the of the oximetry signal was captured by the respiration effort model.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method of creating a model for predicting a medical event represented by a signal measurement value, which method comprises:
(a) obtaining a signal value representative of a medical event of interest at a time t of interest;
(b) sampling a first segment of a medical predictor signal for a time segment prior to time t to derive a first time lagged dataset representative of the medical predictor signal for such time segment prior to time t;
(c) performing a spectral analysis of the first time lagged dataset to obtain a frequency domain representation of the first time lagged dataset;
(d) performing a multiple regression analysis of (i) the frequency domain representation obtained in step (c) as one variable, and (ii) the signal value representative of the medical event obtained in step (a) as another variable, to obtain a model for predicting the medical event based on the correlation between said one variable and said another variable; and
(e) storing the model in a computing device.

2. The method of claim 1, including, in step (b), sampling a segment of a medical predictor signal from a physiological sensor for a time segment prior to time t to derive a first time lagged dataset representative of the medical predictor signal from the physiological sensor for such time segment prior to time t.

3. The method of claim 2, including, in step (b), downsampling a segment of the medical predictor signal from the physiological sensor for a time segment prior to time t to derive a first time lagged dataset having N samples representative of the medical predictor signal from the physiological sensor for a time segment from time t−N to time t.

4. The method of claim 1, including, in step (c), performing the spectral analysis by calculating a fast Fourier transform of the first time lagged dataset derived in step (b) to derive a dataset of predictors in the form of frequency components.

5. The method of claim 4, further comprising reducing the number of predictors via a clustering algorithm before performing step (d).

6. The method of claim 5, further comprising using fast Fourier transform index values, regression coefficient estimates, and regression coefficient values as measures of similarity for the clustering algorithm.

7. The method of claim 1, further comprising sampling a second segment of the medical predictor signal for a time segment after time t to derive a second dataset representative of the medical predictor signal for such time segment after time t, providing the second dataset to the computing device, and operating the computing device to analyze the second dataset with the model to provide an output predictive of the medical event of interest.

8. The method of claim 7, wherein the format of the second dataset is the same as the format of the first dataset.

9. A computer-implemented method of predicting a medical event represented by a signal measurement value, which method comprises:
(a) storing a predictive model in a computing device which model was obtained by:
(i) obtaining a signal value representative of a medical event of interest at a time t of interest;
(ii) sampling a first segment of a medical predictor signal for a time segment prior to time t to derive a first time lagged dataset representative of the medical predictor signal for such time segment prior to time t;
(iii) performing a spectral analysis of the first time lagged dataset to obtain a frequency domain representation of the first time lagged dataset; and
(iv) performing a multiple regression analysis of the frequency domain representation obtained in step (iii) as one variable and the signal value representative of the medical event obtained in step (i) as another variable to derive the model for predicting the medical event based on the correlation between said one variable and said another variable as determined by the multiple regression analysis;
(b) sampling a second segment of the medical predictor signal for a time segment after time t to derive a second dataset representative of the medical predictor signal for such time segment after time t;
(c) performing a spectral analysis of the second time lagged dataset to obtain a frequency domain representation of the second time lagged dataset; and
(d) operating the computing device to analyze the frequency domain representation of the second dataset with the model and to provide an output predictive of the medical event of interest.

10. The method of claim 9, in which the medical predictor signal is a signal from a physiological sensor.

11. The method of claim 9, in which the spectral analysis of (a)(iii) was performed by calculating a fast Fourier transform of the time lagged dataset derived in (a)(ii) to derive a first dataset of predictors in the form of frequency components, followed by reducing the number of predictors via a predetermined clustering algorithm before the multiple regression of (a)(iv) was performed, and in which the spectral analysis of step (c) is performed by calculating a fast Fourier transform of the time lagged dataset derived in step (b) to derive a second dataset of predictors in the form of frequency components, followed by reducing the number of predictors in the second dataset via the predetermined clustering algorithm before step (d).

12. The method of claim 9, wherein the format of the second dataset obtained in step (b) is the same as the format of the first dataset that was obtained in (a)(ii).

13. A signal processing device, comprising:
a processor; and
a nontransitory computer-readable medium having computer-executable instructions stored thereon that, in response to execution by the processor, cause the signal processing device to perform actions for predicting a signal representative of a medical event, the actions including: performing a spectral analysis of a time lagged portion of a set of predictor data, the predictor data representing a time series of measurements of a first physiological state of a patient, to produce a frequency domain representation of the predictor data; and performing a multiple regression over the frequency domain representation as one variable and a signal value representative of the medical event as another variable to create a model for providing a predictive signal of the medical event.
